(19) United States
(12) Patent Application Publication
(10) Pub. No.: US 2015/0342808 A1
(43) Pub. Date: Dec. 3, 2015

(54) U-turner

(71) Applicant: Judith Lynn Laszczyk, Gibbstown, NJ (US)

(72) Inventor: Judith Lynn Laszczyk, Gibbstown, NJ (US)

(21) Appl. No.: 14/287,296

(22) Filed: May 27, 2014

(51) Int. Cl. A61G 7/00

(52) U.S. Cl. CPC A61G 7/001; A61G 2200/32

(57) ABSTRACT

A method and apparatus for turning a patient onto their side without having to place anything under the patient's torso in order to turn the patient are provided.

### BACKGROUND

For many patients who are immobile and/or bed bound, nurses and caregivers frequently need to turn these patient's onto their side in order to complete patient care tasks, such as cleaning the patient's buttocks and changing the linens under the patient. Many patients are unable to move or assist the caregiver with completing these tasks. Currently, most nurses and caregivers use a “draw sheet” (a bed sheet folded in half) or their hands which must be placed under the patient's torso and pulled by the nurse or caregiver in order to turn the patient onto their side. A second person is usually required to assist the caregiver with this method in order to turn and hold the patient on their side while the first caregiver completes the cleaning/changing of linens.

Unfortunately, for nurses and caregivers, this method results in many injuries from poor body mechanics and muscle strain from repetitively lifting and pulling for prolonged periods of time.

### SUMMARY OF DISCLOSURE

Certain embodiments provide a method for turning a patient without having to place anything under the patient's torso.

Certain embodiments provide an apparatus specifically designed to enable a nurse or caregiver to turn a patient without the assistance of a second person to hold them in place.

Certain embodiments provide a method to place the apparatus under the neck and knees of the patient, secure the apparatus to a bed side rail and turn the patient onto their side, again securing the apparatus to the side rail in order to hold the patient on their side while the nurse is able to complete all necessary patient care with minimal strain.

### BRIEF DESCRIPTION OF THE DRAWINGS

The apparatus is made of a durable yet flexible material shaped in the form of a “U” with two side Velcro straps (3), and centrally placed handle (2), and a center Velcro strap (4). The “U” shaped material cradles the side of the patient's torso between the hips and shoulders, acting as a “sling”. The “leverage” or “tension” from the secured straps facilitate the movement of the patient onto their side, thereby reducing the amount of force required by the caregiver to turn the patient.

FIG. 1 illustrates the U turner apparatus design with the handle (2), both side Velcro straps (3) and the center Velcro strap (4).

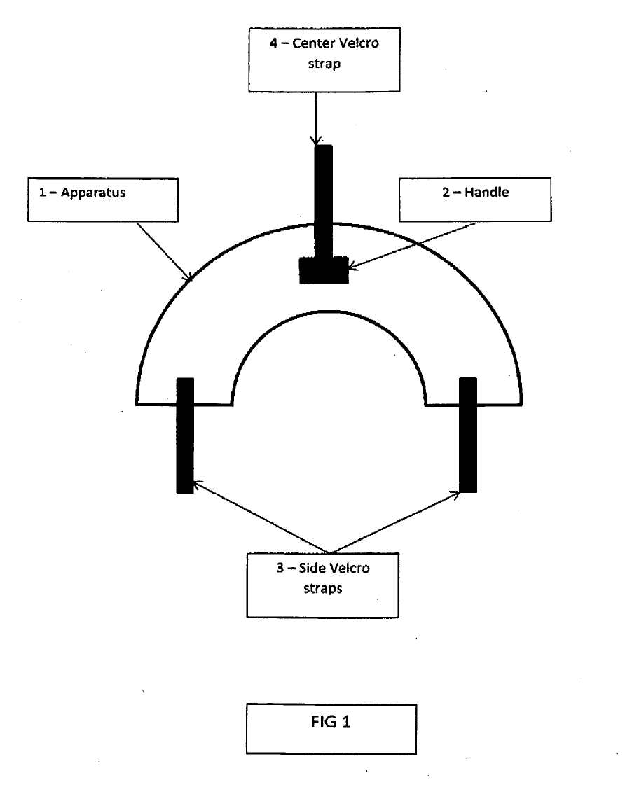

FIG. 2 illustrates the caregiver placing the side Velcro straps under the patient's neck and knees and attaching the side Velcro straps to the side rail.

FIG. 3 illustrates the caregiver pulling the handle to turn the patient onto his side and attaching the center Velcro strap to the side rail.

FIG. 4 illustrates the caregiver returning the patient to a lying position, pulling the two side straps toward the opposite side and attaching the two Velcro side straps to the side rail.

### DETAILED DESCRIPTION

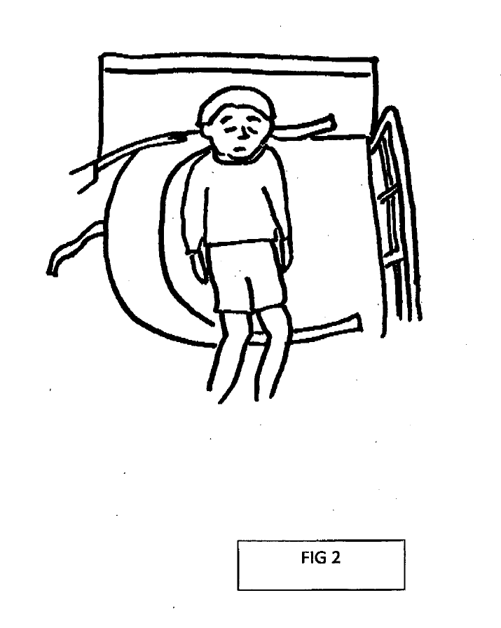

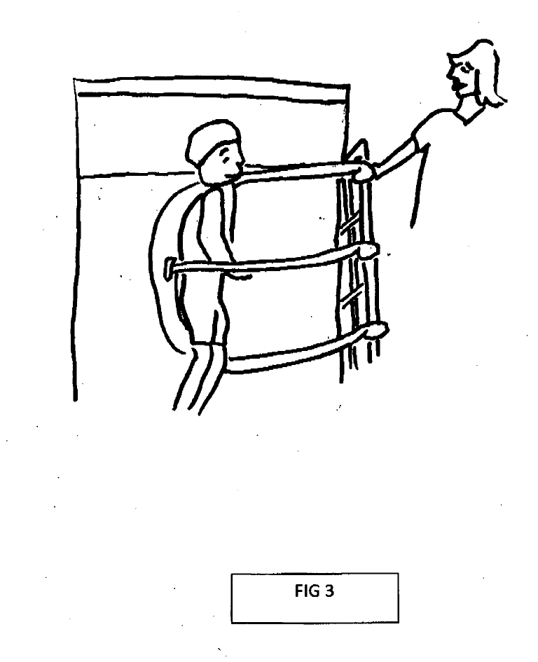

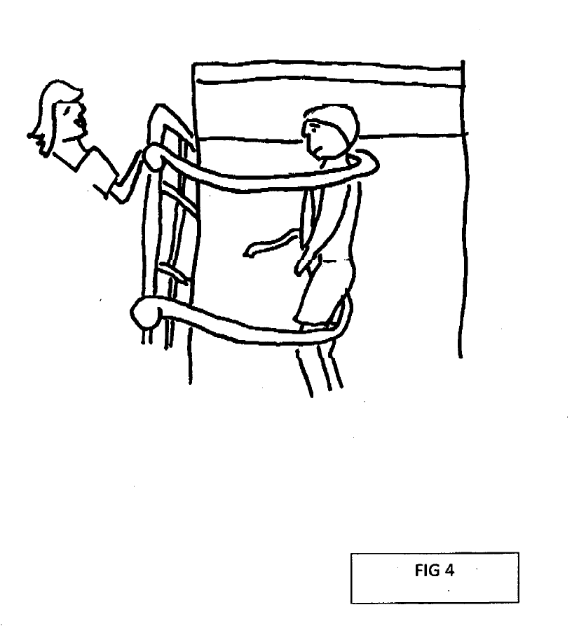

With the patient lying flat on his back in a stretcher or bed with the side rails up, the nurse or caregiver places one of the Side Velcro straps under the patient's neck and the other Side Velcro strap under the patients knees, and the two Side Velcro straps are then attached to the bed or stretcher side rail (FIG. 2). The nurse or caregiver then pulls the Handle to turn the patient onto his side and the Center Velcro strap is then attached to the side rail (FIG. 3). The nurse is then free to provide care to the patient. When completed, the nurse will remove all of the Velcro straps from the side rail and gently return the patient to a lying position, and pull the two side Velcro straps toward the opposite and attach the two Velcro side straps to the side rail (FIG. 4). The nurse may then provide care to the patient. When completed, the nurse will remove all of the Velcro straps from the side rail and gently return the patient to a lying position.

1. A method for turning patients which enables the caregiver to turn a patient lying in bed without having to place the turning apparatus under the patient's torso in order to turn the patient.

2. The method of claim 1 enables the user to place an extension (strap) of the apparatus under the patient's neck and the other extension (strap) of the device under the patient's knees, then to secure the Velcro straps on the apparatus to the side rails of the bed or stretcher.

3. The method of claim 2, the user then pulls a handle located in the center of the apparatus to turn the patient onto their side by pulling the patient gently toward the side rail and attaches another Velcro strap to the side rail to hold the patient in place on his side.

4. The method of claim 3, the user may place patient of their back and pull side straps of the apparatus in order to turn the patient onto their opposite side, securing the side Velcro straps to the opposite side rail of the bed or stretcher.

5. The method and apparatus of claims 1, 2, 3 and 4 is designed to be used by nurses and caregivers to turn immobile patients onto their sides without the help of another person, as this apparatus will hold the patients securely on their side for patient care activities such as cleaning, repositioning and changing linens.

6. An apparatus for turning patients which enables the caregiver to turn a patient lying in bed without having to place the turning apparatus under the patient's torso in order to turn the patient, the apparatus comprising a sling comprised of durable, flexible material shaped and sized to cradle a side of the patient's torso; a first extension (strap) attached at the top of the sling for placement under the patient's neck and securing to the bed; a second extension (strap) attached at the top of the sling for placement under the patient's knees and securing to the bed; a handle attached at the center of the sling for pulling the sling and patient toward the secured first and second extensions, thereby turning the patient; and a center strap attached to the handle for securing to the bed so that the turned patient is held in place.
